(19) United States
(12) Patent Application Publication
(10) Pub. No.: US 2012/0043497 A1
(43) Pub. Date: Feb. 23, 2012

(54) Working Component for Magnetic Heat Exchange and Method of Producing a Working Component for Magnetic Refrigeration

(75) Inventors: Matthias KATTER, Alzenau (DE); Volker Zellmann, Linsengericht (DE); Alexander Barcza, Hanau (DE)

(73) Assignee: Vacuumschmelze GmbH & Co. KG, Hanau (DE)

(21) Appl. No.: 13/026,137

(22) Filed: Feb. 11, 2011

(30) Foreign Application Priority Data
Aug. 18, 2010 (GB) 1013793.3

(51) Int. Cl. C09K 5/04; B23K 9/013; B23K 26/38; B24B 1/00

(52) U.S. Cl. 252/67; 451/36; 451/28; 219/121.72; 219/69.17; 219/121.71

(57) ABSTRACT

A working component for magnetic heat exchange comprises a magnetocalorically active phase comprising La₁₋ₐRₐ(Fe_{1-x-y}T_{y}Mₓ)₁₃H_{z}, a hydrogen content, z, 90% or higher of a hydrogen saturation value, zₛₐₜ, and values of a, x and y selected to give a Curie temperature T_{c}. M is one or more of the elements from the group consisting of Al and Si, T is one or more of the elements from the group consisting of Co, Ni, Mn, Cr, Cu, Ti and V and R is one or more of the elements from the group consisting of Ce, Nd, Y and Pr. T_{cmax} is a Curie temperature of a La₁₋ₐRₐ(Fe_{1-x-y}T_{y}Mₓ)₁₃H_{z} phase comprising a hydrogen content z=zₛₐₜ and said selected values of a, x and y. The working component comprises the T_{c} wherein (T_{cmax}−T_{c})≦20K.

### BACKGROUND

1. Field

Disclosed herein is a working component for magnetic heat exchange and a method of fabricating an article for magnetic heat exchange.

2. Description of Related Art

A magnetocalorically active material exhibits the magnetocaloric effect. The magnetocaloric effect describes the adiabatic conversion of a magnetically induced entropy change to the evolution or absorption of heat. The magnetic entropy of the material changes depending on whether a magnetic field is applied or not owing to the difference between the degrees in freedom of the electron spin system. With this entropy change, entropy transfers between the electron spin system and the lattice system. A magnetocalorically active phase, therefore, has a magnetic phase transition temperature Tₜᵣₐₙₛ at which this entropy change occurs.

Magnetic heat exchangers include a magnetocalorically active material as the working component or working medium to provide cooling and/or heating. By applying a magnetic field to a magnetocalorically active material, an entropy change can be induced which results in the evolution or absorption of heat. This effect can be harnessed to provide refrigeration and/or heating.

Magnetic heat exchangers are, in principle, more energy efficient than gas compression/expansion cycle systems. They are also considered environmentally friendly as chemicals such as chlorofluorocarbons (CFC) which are thought to contribute to the depletion of ozone levels are not used.

Practical magnetic heat exchangers, such as that disclosed in U.S. Pat. No. 6,676,772, typically include a pumped recirculation system, a heat exchange medium such as a fluid coolant, a chamber packed with particles of a working material which displays the magnetocaloric effect and a means for applying a magnetic field to the chamber.

In practice, the magnetic phase transition temperature of the magnetocalorically active material translates as the working temperature. Therefore, in order to provide cooling over a wider temperature range, the magnetic heat exchanger requires magnetocalorically active material having several different magnetic phase transition temperatures. In addition to a plurality of magnetic phase transition temperatures, a practical working medium should also have a large entropy change in order to provide efficient refrigeration and/or heating.

A variety of magnetocalorically active phases are known which have magnetic phase transition temperatures in a range suitable for providing domestic and commercial air conditioning and refrigeration. One such magnetocalorically active material, disclosed for example in U.S. Pat. No. 7,063,754, has a NaZn₁₃-type crystal structure and may be represented by the general formula La(Fe_{1-x-y}T_{y}Mₓ)₁₃H_{z}, where M is at least one element of the group consisting of Si and Al, and T may be one of more of transition metal elements such as Co, Ni, Mn and Cr. The magnetic phase transition temperature of this material may be adjusted by adjusting the composition.

Consequently, magnetic heat exchanger systems are being developed in order to practically realise the advantages provided by the newly developed magnetocalorically active materials. However, further improvements are desirable to enable a more extensive application of magnetic heat exchange technology.

Therefore, it is desirable to provide a material for use as the working medium in a magnetic heat exchanger which can be fabricated to have a range of different magnetic phase transition temperatures as well as a large entropy change.

### SUMMARY

In an embodiment of the present application, a working component for magnetic heat exchange comprising a magnetocalorically active phase is provided. The magnetocalorically active phase comprises La₁₋ₐRₐ(Fe_{1-x-y}T_{y}Mₓ)₁₃H_{z}, a hydrogen content, z, that is 90% or higher of a hydrogen saturation value, zₛₐₜ, and values of a, x and y selected to give a Curie temperature T_{c}. M is one or more of the elements from the group consisting of Al and Si, T is one or more of the elements from the group consisting of Co, Ni, Mn, Cr, Cu, Ti and V and R is one or more of the elements from the group consisting of Ce, Nd, Y and Pr. T_{cmax} is the Curie temperature of a La₁₋ₐRₐ(Fe_{1-x-y}T_{y}Mₓ)₁₃H_{z} phase comprising a hydrogen content z=zₛₐₜ and said selected values of a, x and y. The difference between T_{cmax} and T_{c} of the working component is less than 20K, i.e. (T_{cmax}−T_{c})≦20K.

The La₁₋ₐRₐ(Fe_{1-x-y}T_{y}Mₓ)₁₃H_{z} phase has a NaZn₁₃-type structure in which the hydrogen atoms occupy intersitital sites. The working component, therefore, comprises a hydrogen content which is at least 90% of the hydrogen saturation content. In a further embodiment, the hydrogen content, z, is at least 95% of the hydrogen saturation content, zₛₐₜ, and (T_{cmax}−T_{c})≦10K.

The hydrogen saturation content, zₛₐₜ, of the La₁₋ₐRₐ(Fe_{1-x-y}T_{y}Mₓ)₁₃H_{z}-type phase is not a constant, but varies depending on the R, T and M and the values a, x and y. Therefore, the hydrogen saturation content, zₛₐₜ, depends on the type of metallic element as well as the amounts of the metallic elements included as substituting elements in the LaFe₁₃ base phase.

For a sample with selected values of a, x and y, the hydrogen saturation content can be experimentally determined by heating a hydrogenated sample in a hydrogen containing atmosphere at a temperature in the range 20° C. to 100° C. for at least 1 hour. The hydrogen-containing atmosphere may comprise a hydrogen partial pressure in the range of 0.5 bar to 2.0 bar. The sample may be preheated in the hydrogen atmosphere to temperatures between 200° C. to 500° C. before it is held at a temperature of 20° C. to 100° C. for at least one hour. The preheating step aids in avoiding activation difficulties.

If the hydrogen content of the sample does not measurably increase, the sample can be said to be fully hydrogenated and contain the hydrogen saturation content, zₛₐₜ. The hydrogen content of the sample can be measured using techniques such as the hot gas extraction method. Alternatively, or in addition, the change of the hydrogen content can be evaluated by measuring the Curie temperature before and after this heat treatment.

In the La₁₋ₐRₐ(Fe_{1-x-y}T_{y}Mₓ)₁₃H_{z} phase, the maximum value of the Curie temperature is achieved in compositions in which the hydrogen content, z, is equal to the hydrogen saturation content, zₛₐₜ, for given values of a, x and y.

The metallic elements R and T may be selected to adjust the Curie temperature of both the hydrogenated and unhydrogenated phase. For example, substituting the elements Nd, Pr, and/or Ce for La and/or Mn, Cr, V and Ti for Fe leads to a reduction in the Curie temperature. The Curie temperature can also be increased by substituting Fe with Co and Ni.

The Curie temperature of a La₁₋ₐRₐ(Fe_{1-x-y}T_{y}Mₓ)₁₃H_{z} phase can also be adjusted to a selected value by adjusting the hydrogen content. The Curie temperature can be reduced from the maximum value T_{cmax} by reducing the hydrogen content and partially dehydrogenating the sample. However, partially hydrogenated samples have been observed to age in that the Curie temperature is unstable if the sample is stored at around Curie temperature over a period of, for example, 30 to 45 days, as would occur for a working component in a practical magnetic heat exchanger. Furthermore, partially hydrogenated La(Fe, Si)₁₃H_{z} samples have also been observed, similar to fully hydrogenated samples La(Fe, Si)₁₃Hₛₐₜ samples, to exhibit thermal hysteresis which is undesired in practical magnetic heat exchangers.

By keeping the hydrogen content as high as possible in La₁₋ₐRₐ(Fe_{1-x-y}T_{y}Mₓ)₁₃H_{z}-based phases, ageing of the working component can be prevented. Therefore, by selecting the appropriate elements R and T and keeping the hydrogen content as high as possible, a working component with a desired value of T_{c} which is stable over a longer working time can be provided.

Additionally, the substitution of the elements R and/or T, in particular Mn, leads to a reduction in the thermal hysteresis observed for the working component compared to samples which do not include the elements R and T. The combination of substantially complete hydrogenation and the substitution with elements R and T can reduce thermal hysteresis and improve the efficiency of the working component in a magnetic heat exchanger.

A magnetocalorically active material is defined herein as a material which undergoes a change in entropy when it is subjected to a magnetic field. The entropy change may be the result of a change from ferromagnetic to paramagnetic behaviour, for example. The magnetocalorically active material may exhibit, in only a part of a temperature region, an inflection point at which the sign of the second derivative of magnetization with respect to an applied magnetic field changes from positive to negative.

A magnetocalorically passive material is defined herein as a material which exhibits no significant change in entropy when it is subjected to a magnetic field.

A magnetic phase transition temperature is defined herein as a transition from one magnetic state to another. Some magnetocalorically active phases exhibit a transition from antiferromagnetic to ferromagnetic which is associated with an entropy change. Magnetocalorically active phases such as La₁₋ₐRₐ(Fe_{1-x-y}T_{y}Mₓ)₁₃H_{z} exhibit a transition from ferromagnetic to paramagnetic which is associated with an entropy change. For these materials, the magnetic transition temperature can also be called the Curie temperature.

In further embodiments the working component comprises a magnetocalorically active phase La₁₋ₐRₐ(Fe_{1-x-y}T_{y}Mₓ)₁₃H_{z} in which 1.2≦z≦3 or 1.4≦z≦3 and/or 0.05≦x≦0.3, 0.003≦y≦0.2 and optionally 0.005≦a≦0.5. In a further embodiment, 1.2≦z≦3 and 0.05≦a≦0.5 and 0.05≦x≦0.2 and 0.003≦y≦0.2.

As discussed above, the Curie temperature of the working component can be adjusted by adjusting the amount of the substituting elements R and T. In one embodiment, T is Mn and the Curie temperature T_{c} of the working component lies within ±10K of the value of the Curie temperature, T_{c(calc)}, derived from the relationship T_{c(calc)} (° C.)=80.672−26.957×Mnₘ, wherein Mnₘ is the metallic weight fraction of manganese. In a further embodiment, T_{c} lies within ±5K of T_{c(calc)}.

As used herein, the subscript m denotes the metallic weight fraction. The metallic weight fraction is defined herein as the result of a calculation separating and removing the rare earth, RE, content which is bonded in the form of RE oxides and RE nitrides from the total composition according to the following formulas (for RE=La):

$${La}_{2} {O}_{3} = 6.79 * O$$

$$LaN = 10.9 * N$$

$$f = \frac{100}{100 - {La}_{2} {O}_{3} - LaN}$$

Consequently,

Laₘ=(La−5.8*O−9.9*N)*f

Siₘ=Si*f

Coₘ=Co*f

Mnₘ=Mn*f

where the subscript m denotes the metallic weight fraction and La, O, N, Si, Co and Mn and so on denote the weight percent of this element.

In a first approximation, the metallic RE content can also be calculated for La-rich alloys as:

$$R {E}_{m} = ( R E - 5.8 * O - 9.9 * N ) \times \frac{100}{100 - 6.8 * O - 10.9 * N}$$

For Si, Co, Mn and so on, the metallic contents are close to the total content as the factor f is around 1.02. However, for the RE element, there is a larger difference. For example, in the embodiments described here, a content of around 18 wt % La is used to provide a metallic content of 16.7 wt % which corresponds to the stoichiometry of the 1:13 phase.

In further embodiments, the amount of the element M can be adjusted depending on the type and amount of the substituting elements R and T in order to achieve a larger entropy change in the La₁₋ₐRₐ(Fe_{1-x-y}T_{y}Mₓ)₁₃H_{z} phase. In an embodiment, M is Si and the metallic weight fraction of Si, Si_{act}, lies within ±5% of the value of the metallic weight fraction of silicon, Siₘ, derived from the relationship Siₘ=3.85−0.0573×Coₘ−0.045×Mnₘ²+0.2965×Mnₘ., wherein Mnₘ is the metallic weight fraction of Mn and Coₘ is the metallic weight fraction of Co.

In an embodiment, M is Si and the metallic weight fraction of Si, Si_{act}, lies within ±5% of the value of the metallic weight fraction of silicon, Siₘ, derived from the relationship Siₘ=3.85−0.045×Mnₘ²+0.2965×Mnₘ+(0.198−0.066×Mnₘ)×Ce(MM)ₘ, wherein Ce(MM)ₘ is the metallic weight fraction of cerium misch metal (Mischmetall).

In a further embodiment, Si_{act} lies within ±−2% of Siₘ.

The working component can be provided in a number of physical forms. For example, the working component may comprise a powder, a sintered block, a reactively sintered block or a compacted powder.

The term “reactively sintered” describes an article in which grains are joined to congruent grains by a reactively sintered bond. A reactively sintered bond is produced by heat treating a mixture of precursor powders of differing compositions. The particles of different compositions chemically react with one another during the reactive sintering process to form the desired end phase or product. The composition of the particles, therefore, changes as a result of the heat treatment. The 3Q phase formation process also causes the particles to join together to form a sintered body having mechanical integrity.

Reactive sintering differs from conventional sintering since, in conventional sintering, the particles consist of the desired end phase before the sintering process. The conventional sintering process causes a diffusion of atoms between neighbouring particles so as join the particles to one another. The composition of the particles, therefore, remains unaltered as a result of a conventional sintering process.

The working component may further comprise a magnetocalorically passive phase. This magnetocalorically passive phase may provide a matrix in which the magnetocalorically active phase is embedded. Alternatively, the magnetocalorically passive phase may provide a coating of a massive magnetocalorically active block. In both cases, the magnetocalorically passive phase may provide a corrosion resistance coating to prevent corrosion of the magnetocalorically active phase.

As mentioned above, a practical magnetic heat exchanger typically includes a magnetocalorically active working medium having two or more differing Curie temperatures. In an embodiment, an article for magnetic heat exchange comprising two or more working components according to one of the previously described embodiments is provided. The two or more working components have differing Curie temperatures and differing values of a and/or x and/or y in order to provide the differing Curie temperatures. In each case, the hydrogen content, z, of the two or more working components is at least 90%, or at least 95%, of the saturation value, zₛₐₜ, for a La₁₋ₐRₐ(Fe_{1-x-y}T_{y}Mₓ)₁₃H_{z} phase having these particular values of a, x and y included in the working component.

In a further embodiment, the article comprises at least three working components with differing Curie temperatures. The at least three working components are arranged so that the Curie temperature of the working components increases in a direction of the article. The article may include as many working components with differing Curie temperatures as is desirable. For example, the article may comprise 5, 6 or 7 working components with differing Curie temperatures arranged so that the Curie temperature of the working components increases in a direction of the article.

A method of producing a working component for magnetic refrigeration comprises selecting a desired Curie temperature and selecting an amount of one or more elements T, R and M, wherein T is one or more of the elements from the group consisting of Mn, Co, Ni Cu, Ti, V and Cr, R is one or more of the elements from the group consisting of Ce, Nd, Y and Pr, M is one or more of the elements Si and Al, the amount of the one or more elements T, R and M being selected to produce the desired Curie temperature when included in a La₁₋ₐRₐ(Fe_{1-x-y}T_{y}Mₓ)₁₃H_{z} phase having a hydrogen content that is at least 90% of a hydrogen saturation value, zₛₐₜ. The amount of the selected elements T, R and M are mixed with La and Fe or precursors thereof in amounts suitable for producing the La₁₋ₐRₐ(Fe_{1-x-y}T_{y}Mₓ)₁₃H_{z} phase with the desired Curie temperature to produce a precursor powder mixture. The precursor powder mixture is heat treated to produce an intermediate product comprising a La₁₋ₐRₐ(Fe_{1-x-y}T_{y}Mₓ)₁₃H_{z} phase with z=0. The intermediate product is hydrogenated to produce a working component comprising the La₁₋ₐRₐ(Fe_{1-x-y}T_{y}Mₓ)₁₃H_{z} phase comprising the desired Curie temperature and a hydrogen content z of at least 90% or at least 95% of the hydrogen saturation value, zₛₐₜ.

The amount of one or more of the elements R, T and M may be selected within the ranges 0.05≦x≦0.2, 0.003≦y≦0.2 and optionally 0.005≦a≦0.5 to provide the desired Curie temperature, when the La₁₋ₐRₐ(Fe_{1-x-y}T_{y}Mₓ)₁₃H_{z} phase comprises a hydrogen content z of at least 90% of the hydrogen saturation value, zₛₐₜ. In a further embodiment, the amount of one or more of the elements R, T and M is selected within the ranges 0.005≦a≦0.5 and 0.05≦x≦0.2 and 0.003≦y≦0.2.

In one embodiment, the element T comprises Mn and the amount of manganese Mnₘ to produce the desired Curie temperature T_{c} is selected according to T_{c} (° c.)=80.672−26.957×Mnₘ, wherein Mnₘ is the metallic weight fraction of manganese.

In a further embodiment, M is Si and the amount of Si is selected according to Siₘ=3.85−0.0573×Coₘ−0.045×Mnₘ²+0.2965×Mnₘ, wherein Mnₘ is the metallic weight fraction of manganese and Coₘ is the metallic weight fraction of cobalt.

In a further embodiment, M is Si and the amount of Si is selected according to Siₘ=3.85−0.045×Mnₘ²+0.2965×Mnₘ+(0.198−0.006×Mnₘ)×Ce(MM)ₘ, wherein Mnₘ is the metallic weight fraction of manganese and Ce(MM)ₘ, is the metallic weight fraction of cerium misch metal.

The precursor powder mixture may be pressed to form one or more green bodies before the heat treating and hydrogenated processes are carried out. Isostatic or die pressing may be used. This embodiment may be carried out to produce the working component in the form of a reactively sintered block. Alternatively, pressing may be carried out to increase the reaction rate and phase formation in the green body. After formation of the working component with the magnetocalorically active phase, the working component may be subsequently milled to provide working component powder.

As discussed above, the hydrogenation is carried out in order to provide a working component with a hydrogen content, z, of at least 90% or at least 95% of the hydrogen saturation value, zₛₐₜ. In an embodiment, the intermediate product is hydrogenated to produce the La₁₋ₐRₐ(Fe_{1-x-y}T_{y}Siₓ)₁₃H_{z} phase with a hydrogen content z of 1.2≦z≦3, preferably 1.4≦z≦3.

The hydrogenation conditions are chosen so as to introduce sufficient hydrogen into the La₁₋ₐRₐ(Fe_{1-x-y}T_{y}Mₓ)₁₃H_{z} phase in order to produce a hydrogen content z of at least 90% of the hydrogen saturation value, zₛₐₜ. Hydrogenation may be performed by heat treating the intermediate product under a hydrogen partial pressure of 0.5 to 2 bars. The hydrogen partial pressure may be increased during the hydrogenation heat treatment. The hydrogenation may comprise heat treating at a temperature in the range of 0° C. to 100° C. and, preferably, in the range 15° C. to 35° C. A final heat treatment at temperatures of less than 100° C. in a hydrogen atmosphere, preferably at 1.5 to 2 bars has been found to reliably produce working components with the hydrogen content, z, of at least 90% of the hydrogen saturation value, zₛₐₜ.

In further embodiments, the hydrogenation comprises a dwell at a temperature T_{hyd}, wherein 300° C.≦T_{hyd}≦700° C. and may comprises a dwell at a temperature T_{hyd} in the range 400° C.≦T_{hyd}≦500° C. followed by cooling to a temperature of less than 100° C.

In further embodiments, the intermediate product is only subjected to hydrogen gas above a threshold temperature. In one embodiment, the hydrogenation comprises heating the intermediate product from a temperature of less than 50° C. to at least 300° C. in an inert atmosphere and introducing hydrogen gas only when a temperature of at least 300° C. is reached. The intermediate product is maintained in a hydrogen containing atmosphere at a temperature in the range 300° C. to 700° C. for a selected duration of time, and cooled to a temperature of less than 50° C. in a hydrogen-containing atmosphere to provide the working component. This method has been found to result in working components with a hydrogen content, z, of 90% or more of the hydrogen saturation content, zₛₐₜ, and also in mechanically stable working components. This hydrogenation process may be used to produce working components in the form of the sintered block or a reactively sintered block.

In particular, it is found that if hydrogen is first introduced at temperatures lower than around 300° C., the bulk precursor article may disintegrate into pieces or at least lose its previous mechanical strength. However, these problems may be avoided by first introducing hydrogen when the bulk precursor article is at a temperature of at least 300° C.

Alternatively, or in addition, hydrogen gas is introduced only when a temperature of 400° C. to 600° C. is reached. After hydrogenation, the working component may comprise at least 0.18 wt % hydrogen.

In order to form the intermediate product comprising a La₁₋ₐRₐ(Fe_{1-x-y}T_{y}Mₓ)₁₃H_{z} phase with z=0, the precursor powder mixture may be heat treated at a temperature Tₛᵢₙₜₑᵣ, wherein 1050° C.≦Tₛᵢₙₜₑᵣ≦1200° C.

A multi-step heat treating process may also be used to heat treat the powder mixture and produce the intermediate product. In an embodiment, the multi-step heat treatment comprises a first dwell at Tₛᵢₙₜₑᵣ for a time t₁ in vacuum and a time t₂ in argon, followed by cooling to a temperature T₁, wherein T₁<Tₛᵢₙₜₑᵣ, followed by a second dwell at T₁ for a time t₃ followed by rapid cooling. Typical parameter ranges for such a multi-step heat treatment may be 1000° C.≦T₁≦1080° C. and/or 0.5 h≦t₁≦10 h and/or 0.5 h≦t₂≦10 h and/or 1 h≦t₃≦20 h and/or rapid cooling at a rate of 5 to 200° C./min.

In embodiments in which the working component comprises a silicon content, the silicon content, Si_{act} of the working component may lie within ±5% or ±2% of Siₘ.

The mixing of the precursor powders may be carried out using steel balls and, optionally, isopropanol in order to more intimately mix the elements. The milling time may be restricted to a maximum of 1 hour.

The working component may be provided in a number of forms depending on the design of the magnetic heat exchanger. Therefore, the working component may be further milled to produce working component powder. The working component powder may be further heat treated at temperatures in the range of 100° C. to 200° C. for 5 to 60 minutes. This heat treatment may be carried out in Argon.

If the working component is provided in the form of a block, whether it be a sintered block or a reactively sintered block, it may be desirable to work the working component by removing at least one portion to change its outer dimensions. For example, it may be desirable to singulate the working component into two or more separate pieces, and/or adjust the outer dimensions and/or it may be desirable to introduce channels or through holes in the working component through which a fluid heat exchange medium can flow.

The at least one portion may be removed from the working component by one or more of machining, mechanical grinding, mechanical polishing, chemical-mechanical polishing, electric spark cutting, wire erosion cutting, laser cutting and laser drilling or water beam cutting.

However, it has been found that the magnetocalorically active phase is difficult to work since it is mechanically unstable. Therefore, a number of alternative measures may be taken in order to remove one or more portions of the working component so as to reliably achieve the desired outer dimensions.

In one set of embodiments, the at least one portion of the working component is removed whilst the working component remains at a temperature above the Curie temperature or below the Curie temperature. This has been found to avoid undesired cracking of the working component.

Heating or cooling of the article may be performed by applying a heated or cooled working fluid such as water, an organic solvent or oil, for example.

Without being bound by theory, if, during working, the temperature of the article changes so that the article undergoes a phase change, this phase change may result in the formation of cracks within the article.

The magnetocalorically active phase may exhibit a temperature dependent transition in length or volume. In this case, the at least one portion may be removed at a temperature above the transition or below the transition to avoid a transition in length or volume during removal of the portion or portions. The temperature at which this transition of length or volume occurs may correspond roughly to the Curie temperature.

The transition may be characterized by (L_{10%}−L_{90%})×100/L(T)>0.35, wherein L is the length of the article at temperatures below the transition, L_{10%} is the length of the article at 10% of the maximum length change and L_{90%} at 90% of the maximum length change. This region characterizes the most rapid change in length per unit of temperature T.

Performing the working of the article by removing one or more portions, whilst the article is maintained at a temperature at which the phase change does not occur, avoids the phase change occurring in the article during working and avoids any tension associated with the phase change occurring during working of the article. Therefore, the article may be worked reliably, the production quota increased and production costs reduced.

A combination of these methods may also be used on a single article. For example, the article may be singulated into two or more separate pieces by removing a portion of the article by wire erosion cutting and then the surfaces subjected to mechanical grinding, removing a further portion, to provide the desired surface finish or more exactly defined outer dimensions.

Typically, removing portions of the working component, for example, by grinding or sawing, creates heat in the working component due to the friction between the tool and the working component. Therefore, by actively cooling at a temperature sufficient to compensate for this heat generation, the magnetocalorically active phase is prevented from undergoing a phase change so that the working component can be reliably formed to the desired outer dimensions.

In a further set of embodiments, the working component is heat treated so as to decompose the magnetocalorically active phase to produce an intermediate article. This intermediate article can then be worked, for example, to remove at least one portion, and the intermediate article or articles can be reheat treated after working to reform the magnetocalorically active phase. By removing portions of the intermediate article which does not include a magnetocalorically active phase, such as a La₁₋ₐRₐ(Fe_{1-x-y}T_{y}Mₓ)₁₃H_{z} phase, in a substantial amount, the intermediate article can be reliably worked without undesirable cracking of the intermediate article.

Particularly in the case of working articles comprising the magnetocalorically active phase La₁₋ₐRₐ(Fe_{1-x-y}T_{y}Mₓ)₁₃H_{z} phase and having larger dimensions, for example blocks having dimensions of at least 5 mm or several tens of millimetres, the inventors have previously observed that undesirable cracks were formed in the articles during working which limited the number of smaller articles with the desired dimensions which could be produced from the large article.

The inventors further observed that this undesirable cracking can be largely avoided by heat treating the article to form an intermediate article which comprises a permanent magnet. The intermediate article comprises a coercive field strength of greater than 10 Oe according to the definition of permanent magnet used herein.

Without being bound by theory, it is thought that the observed cracking articles comprising the magnetocalorically active phase during working may be caused by a temperature dependent phase change occurring in the magnetocalorically active phase. The phase change may be a change in entropy, a change from ferromagnetic to paramagnetic behaviour or a change in volume or a change in linear thermal expansion.

Performing the working of the article whilst the article is in a non-magnetocalorically active working condition avoids the phase change occurring in the article during working and avoids any tension associated with the phase change occurring during working of the article. Therefore, the article may be worked reliably, the production quota increased and production costs reduced.

In one embodiment, the working component is heat treated at a temperature T₂ to form an intermediate article comprising at least one permanently magnetic phase, wherein T₂<Tₛᵢₙₜₑᵣ. T₂ may be in the range of 600° C. to 1000° C.

The working component may be heat treated under conditions selected so as to decompose the La₁₋ₐRₐ(Fe_{1-x-y}T_{y}Mₓ)₁₃H_{z} phase having a NaZn₁₃-type crystal structure and form at least one α-Fe-type phase in the intermediate article. The heat treatment conditions may be selected so as to produce an intermediate article comprising a α-Fe content of greater than 50 vol %. The intermediate article may then be worked at room temperature.

After the intermediate article has been worked by removing at least one portion of the intermediate article, the intermediate article can be heat treated to produce a final working component product comprising at least one magnetocalorically active La₁₋ₐRₐ(Fe_{1-x-y}T_{y}Mₓ)₁₃H_{z} phase. The intermediate article may be heat treated at a temperature T₃ to produce the final product comprising at least one magnetocalorically active La₁₋ₐRₐ(Fe_{1-x-y}T_{y}Mₓ)₁₃H_{z} phase, wherein T₃>T₂. In an embodiment, T₃<Tₛᵢₙₜₑᵣ. T₃ may be around 1050° C.

The composition of the working component may be selected so as to produce a reversible decomposition of the phase with the NaZn₁₃-type crystal structure at T₂ and to produce a reformation of the NaZn₁₃-type crystal structure at T₃.

In an embodiment, the composition of the at least one La₁₋ₐRₐ(Fe_{1-x-y}T_{y}Mₓ)₁₃H_{z} phase is selected so as to exhibit a reversible phase decomposition reaction. This enables the La₁₋ₐRₐ(Fe_{1-x-y}T_{y}Mₓ)₁₃H_{z} phase to be formed in a first step, decomposed to provide the intermediate product and then afterwards reformed in a further heat treatment once working is complete.

The composition of the at least one La₁₋ₐRₐ(Fe_{1-x-y}T_{y}Mₓ)₁₃H_{z} phase may be selected so as to exhibit a reversible phase decomposition reaction into at least one α-Fe-based phase and La-rich and Si-rich phases.

In a further embodiment, the composition of the at least one La₁₋ₐRₐ(Fe_{1-x-y}T_{y}Mₓ)₁₃H_{z} phase is selected so that the at least one La₁₋ₐRₐ(Fe_{1-x-y}T_{y}Mₓ)₁₃H_{z} phase is formable by liquid-phase sintering. This enables an article with a high density to be produced and also an article with a high density to be produced in an acceptable time.

In an embodiment, the intermediate article comprises a composition, in total, in which a=0, T is Co and M is Si and z=0 and in a further embodiment 0<y≦0.075 and 0.05<x≦0.1 when a=0, T is Co and M is Si and z=0.

In further embodiments, the intermediate article comprises the following magnetic properties: Bᵣ>0.35T and H_{cJ}>80 Oe and/or Bₛ>1.0 T.

The intermediate article may have a coercive field strength of greater than 10 Oe but less than 600 Oe. Articles with such a coercive field strength are sometimes called half hard magnets.

The intermediate article may comprise a composite structure comprising a non-magnetic matrix and a plurality of α-Fe- inclusions distributed in the non-magnetic matrix. As used herein, non-magnetic refers to the condition of the matrix at room temperature and includes paramagnetic and diamagnetic materials as well as ferromagnetic materials with a very small saturation polarization.

### BRIEF DESCRIPTION OF DRAWINGS

Embodiments will be now described with reference to the drawings.

FIG. 1 illustrates an article for magnetic heat exchange comprising five separate working components,

FIG. 2 illustrates a graph of entropy change for a magnetic field change of 16 kOe as a function of temperature for various Mn contents,

FIG. 3 illustrates differential scanning calorimetry measurements for a sample with a manganese content of 2.5 wt % in the as prepared state as well as after storage for 45 days at 11° C.,

FIG. 4 illustrates differential scanning calorimetry measurements for a sample with a manganese content of 2.0 wt % in the as prepared state as well as after storage for 45 days at 26° C.,

FIG. 5 illustrates a comparison sample which comprises a lower hydrogen content,

FIG. 6 illustrates a graph of the temperature dependence of the adiabatic temperature change in a magnetic field of 19.6 kOe for three differing samples and a Gd comparison,

FIG. 7 illustrates a graph of the entropy change for a magnetic field change of 16 kOe as a function of temperature for substantially fully hydrogenated samples containing different metallic substitutions,

FIG. 8 illustrates a graph of entropy change for samples having differing Mn and Si contents,

FIG. 9 illustrates the entropy change as a function of temperature for a group of samples according to a second embodiment,

FIG. 10 illustrates the entropy change as a function of temperature for a group of samples according to a second embodiment,

FIG. 11 illustrates a graph illustrating the reduction in Curie temperatures for increasing the manganese content, and

FIG. 12 illustrates a graph of the manganese content and hydrogen content of the samples of the second embodiment.

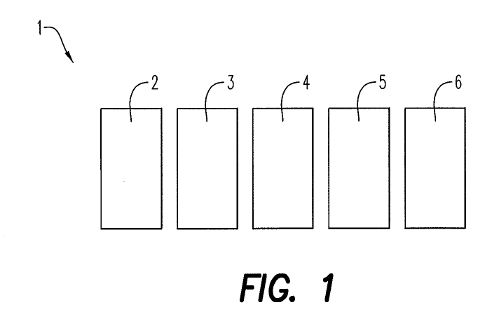

FIG. 1 illustrates an article 1 for magnetic heat exchange comprising five working components 2, 3, 4, 5, 6. Each of the working components 2, 3, 4, 5, 6 comprises a magnetocalorically active phase comprising La₁₋ₐRₐ(Fe_{1-x-y}T_{y}Mₓ)₁₃H_{z}. M may be one or more of the elements from the group consisting of Al and Si, T may be one or more of the elements from the group consisting of Co, Ni, Mn, Cr, Cu, Ti and V and R may be one or more of the elements from the group consisting of Ce, Nd, Y and Pr.

The hydrogen content, z, of each of the working components is 90% or higher of a hydrogen saturation value, zₛₐₜ. The values of a, x and y are selected to give each working component 2, 3, 4, 5, 6 a different Curie temperature T_{c}. The differing Curie temperatures are not achieved to a substantial extent by partially dehydrogenating the working components, but by selecting appropriate amounts of elements R, T and M.

T_{cmax} is the Curie temperature of the respective working component La₁₋ₐRₐ(Fe_{1-x-y}T_{y}Mₓ)₁₃H_{z} phase comprising a hydrogen content z=zₛₐₜ and said selected values of a, x and y for each working component 2, 3, 4, 5, 6. The working components 2, 3, 4, 5, 6 are at least 90% fully hydrogenated so that the Curie temperature T_{c} of each of the working components lies within 20 Kelvin of T_{cmax}. In other words (T_{cmax}−T_{c})≦20K. In this particular embodiment, for each of the working components 2, 3, 4, 5, 6, the element M is Si and the element T is Mn and the element R is omitted.

The Curie temperature T_{c} of the working components 2, 3, 4, 5, 6 lies within ±10K of the value of the Curie temperature, T_{c(calc)}, derived from the relationship T_{c(calc)} (° C.)=80.672−26.957×Mnₘ, wherein Mnₘ is the metallic weight fraction of manganese. By adjusting the amount of manganese in the working component 2, 3, 4, 5, 6, the Curie temperature of the working component can be selected to lie within a range of +80° C. to −90° C.

The values of x and y fulfil the following relationship for each of the working components: the metallic weight fraction of Si, Si_{act}, lies within ±5% of the value of the metallic weight fraction of silicon, Siₘ, derived from the relationship Siₘ=3.85−0.0573×Coₘ−0.045×Mnₘ²+0.2965×Mnₘ. By adjusting the silicon content in relation to the amounts of substituting metals R and T, the NaZn₁₃-type structure can be stabilised.

In this embodiment, each of the working components 2, 3, 4, 5, 6 is produced by reactively sintering the elements or precursors thereof to form a working component in the form of a reactively sintered block. In other embodiments, the working components comprise powder, a sintered block or a compacted powder.

The working components 2, 3, 4, 5, 6 may also be provided as a composite further comprising a magnetocalorically passive phase such as copper in which the magnetocalorically active phase is embedded.

The working components 2, 3, 4, 5, 6 are arranged in the article 1 so that the T_{c} of the working components increases sequentially in a long direction of the article 1. This arrangement produces a better overall cooling performance when the article 1 is used in a magnetic heat exchanger.

The working components 2, 3, 4, 5, 6 may be fabricated using one of the following embodiments.

In an embodiment, La, Fe and Si precursor alloys were mixed with either 1.67 wt % or 10 wt % manganese powder and milled with a jet mill under a protective atmosphere to form two fine powders, each with a particle size of around 6 μm. The two powders were mixed with each other in appropriate amounts to produce four different powders of differing manganese content. Each of the samples included 18 wt % La, 4.2 wt % Si, and one of 1.67 wt %, 2.0 wt %, 2.5 wt % and 3.0 wt % percent Mn, rest Fe.

The powders were isostatically pressed to form green bodies and sintered at 1100° C. for 4 hours followed by cooling to 1050° C. in 72 hours. After a dwell for 6 hours at 1050° C., the samples were cooled at around 50° C. per minute to a temperature of less than 300° C. The samples were then heated under argon to 500° C. and the argon exchanged for 1.9 bars of hydrogen at this temperature. The samples were then cooled in 6 hours to room temperature in the hydrogen containing atmosphere. This heat treatment resulted in material comprising chunks having dimensions of around 10 millimetres. These pieces were mechanically milled and sifted to give a particle size of less than 250 μm. These powders were then heated at 150° C. for 15 minutes.

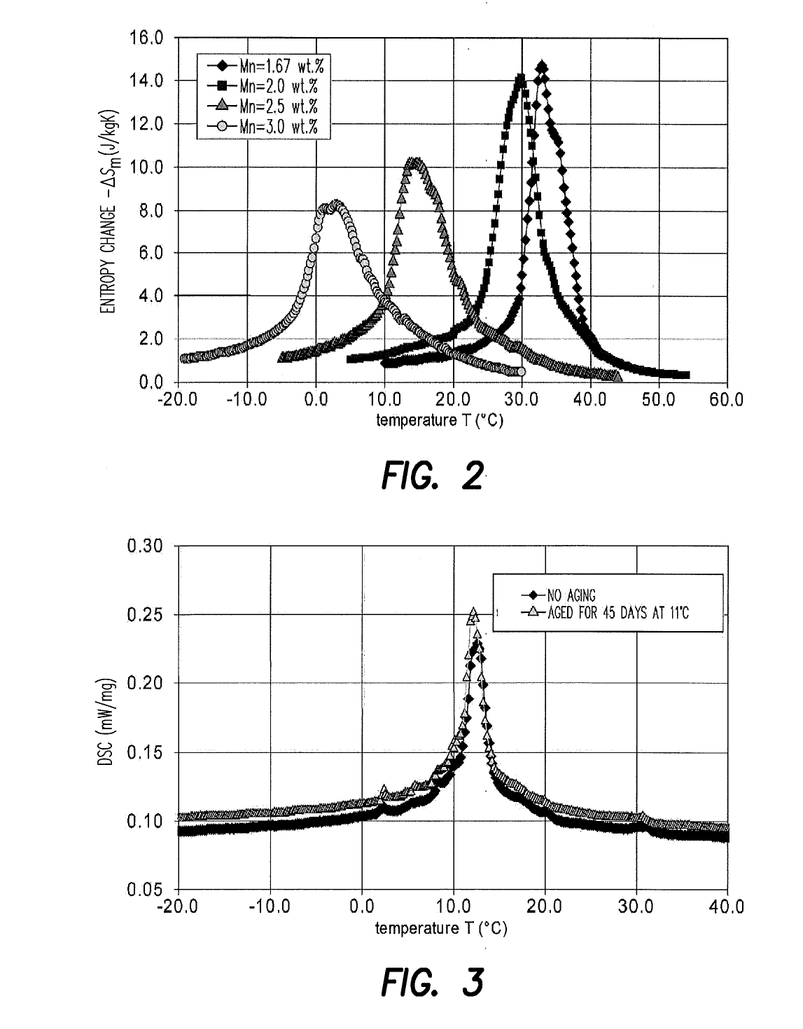

FIG. 2 illustrates a graph of entropy change (−ΔSₘ) upon application of a magnetic field change of 16 kOe as a function of temperature (in ° C.) for the four compositions and illustrates that an increase in the manganese content leads to a systematic reduction in the measured peak temperature. The measured peak temperature corresponds to the Curie temperature.

The following relationship can be used to provide an appropriate Mn content so as to provide the desired T, for fully or substantially fully hydrogenated samples:

T_{c} (° c.)=80.672−26.957×Mnₘ

wherein Mnₘ is the metallic weight fraction of manganese.

FIG. 3 illustrates differential scanning calorimetry measurements for the sample with a manganese content of 2.5 wt % in the as prepared state as well as after storage for 45 days at the Curie temperature. The position of the peak and the form of the curve has not changed significantly after storage.

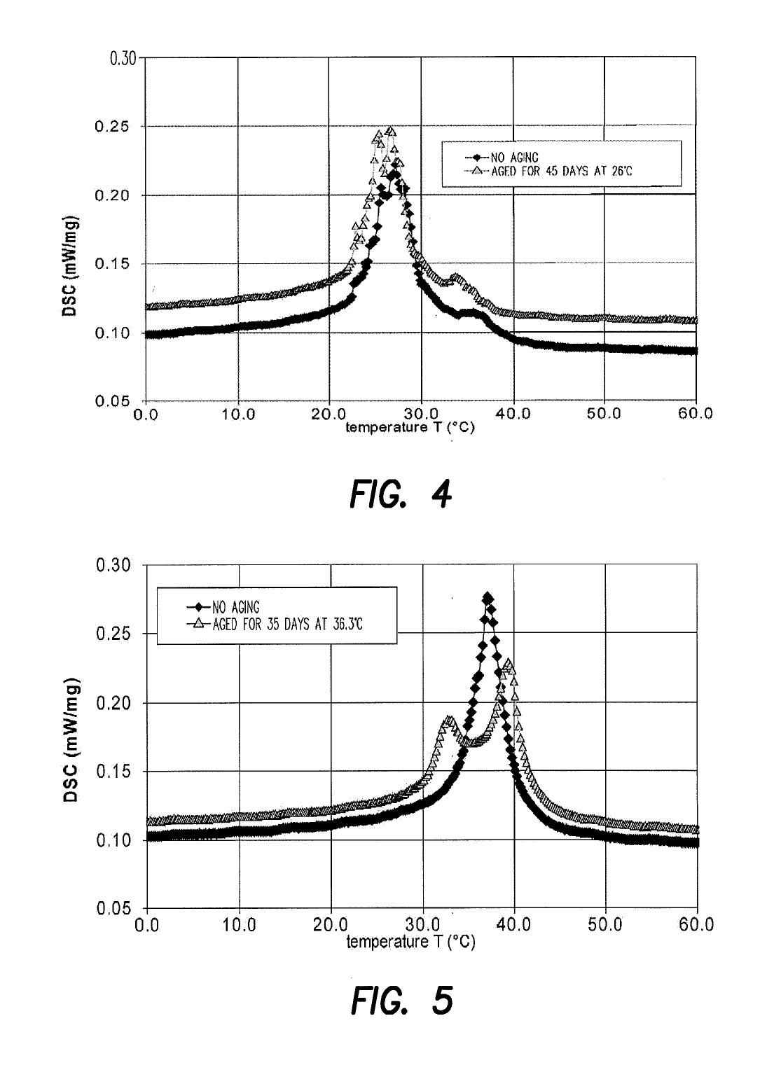

FIG. 4 illustrates differential scanning calorimetry measurements for the sample with a manganese content of 2.0 wt % in the as prepared state as well as after storage for 45 days at the Curie temperature. The position of the peak and the form of the curve has not changed significantly after storage.

FIG. 5 illustrates a comparison sample which comprises a lower hydrogen content, estimated to be 1.143 wt %. The composition of the sample is La_{1.04}(Fe_{0.88}Si_{0.12})₁₃ and the lower hydrogen content was achieved by hydrogenating the sample at 241° C. for 4 hours in a mixture of 22% hydrogen and 78% helium. The differential scanning calorimetry curves are obtained for this sample before and after storage at 35° C. for 35 days at around the Curie temperature of 36° C. (+0.5° C.). The sample before storage is characterised by a single peak which is relatively narrow. After storage for 35 days, two peaks can be seen illustrating that the sample is unstable and appears to disintegrate into two phases each comprising a different Curie temperature. Unstable material with an unstable Curie temperature is undesirable for use in practical magnetic heat exchangers.

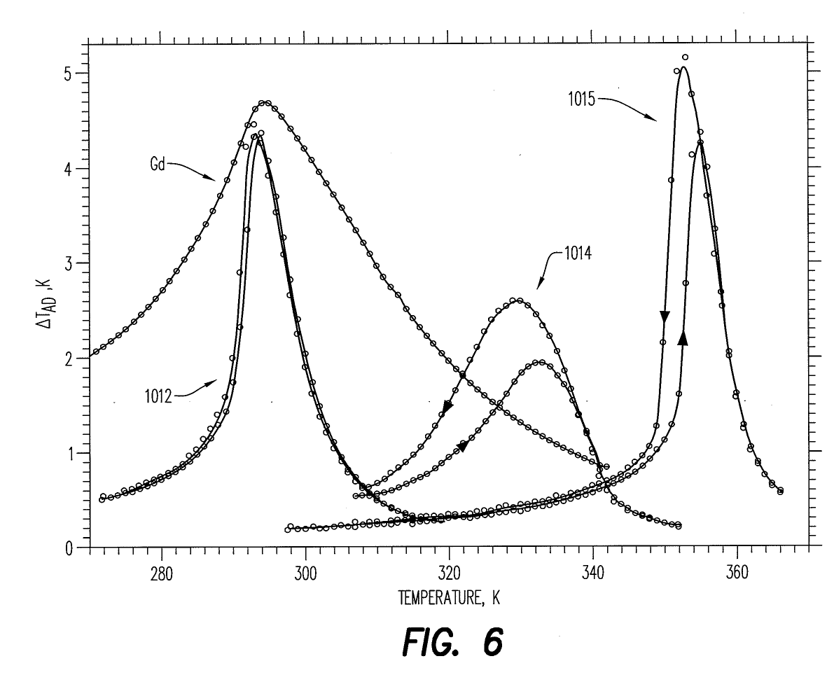

The temperature dependence of the adiabatic temperature change (ΔT_{AD}) in a magnetic field of 19.6 kOe was measured for the following three samples in comparison to Gd and is illustrated in the graph of FIG. 6.

Sample 1012 has a composition of 2.2 wt % Mn and a hydrogen content of 0.187 wt % and is substantially fully hydrogenated.

Sample 1015 has a composition of 17.8 wt % La, 3.81 wt % Si rest Fe and is nearly fully saturated with hydrogen,

Sample 1014 has a composition of 17.8 wt % La, 3.81 wt % Si rest Fe and is partially dehydrogenated.

The measurements were performed by varying the magnetic field between 0 and 19.6 kOe firstly at increasing temperature. The temperature change of each sample was measured with a thermocouple. After the maximum temperature was reached, the adiabatic temperature change was measured again for decreasing temperature. The manganese-free sample 1015 is found to have a clear hysteresis effect which is not desired for application in a magnetic heat exchanger. The manganese containing sample 1012 comprises a much smaller hysteresis than the manganese-free samples 1014 and 1015. The temperature change for the fully hydrogenated sample 1015 is greater than that for the partly dehydrogenated sample 1014.

Therefore, the fully hydrogenated sample 1012 with a Curie temperature determined by an appropriate manganese content is stable when stored at the Curie temperature of up to 45 days, has a low hysteresis and a large temperature change. This combination of features is desirable for a working component of the practical magnetic heat exchanger.

In a further embodiment, a reduction of the Curie temperature from the value provided by a fully hydrogenated La(Fe,Si)₁₃ phase was achieved through the use of substitutions of Ce, Nd and Pr, also in combination with manganese, Mn. The compositions of the samples are summarized in Table 1. In Table 1, RE denotes the amount of the additional rare earth element Pr, Ce(MM) and Nd and excludes the La content. The compositions are: 17.8 wt % La, 3.8 wt % Si, rest Fe; 5.2 wt % Pr, 12.7 wt % La, 3.8 wt % Si, rest Fe; 7.0 wt % Ce (MM), 10.6 wt % La, 3.9 wt % Si, rest Fe; 6.0 wt % Nd, 11.9 wt % La, 4.4 wt % Si, rest Fe; 2.9 wt % Pr, 15.4 wt % La, 2.2 wt % Mn, 4.2 wt % Si, rest Fe, and 6.1 wt % Ce(MM), 11.9 wt % La, 1.9 wt % Mn, 4.6 wt % Si, rest Fe.

TABLE 1

| | RE | La | Mn | Si | Fe | TS |
|---|---|---|---|---|---|---|
| | (wt. %) | (wt. %) | (wt. %) | (wt. %) | (wt. %) | (° C.) |
| La | 0.0 | 17.8 | 0.0 | 3.8 | rest | 1090 |
| Pr | 5.2 | 12.7 | 0.0 | 3.8 | rest | 1100 |
| Ce (MM) | 7.0 | 10.6 | 0.0 | 3.9 | rest | 1100 |
| Nd | 6.0 | 11.9 | 0.0 | 4.4 | rest | 1160 |
| Pr, Mn | 2.9 | 15.4 | 2.2 | 4.2 | rest | 1120 |
| Ce (MM), Mn | 6.1 | 11.9 | 1.9 | 4.6 | rest | 1140 |

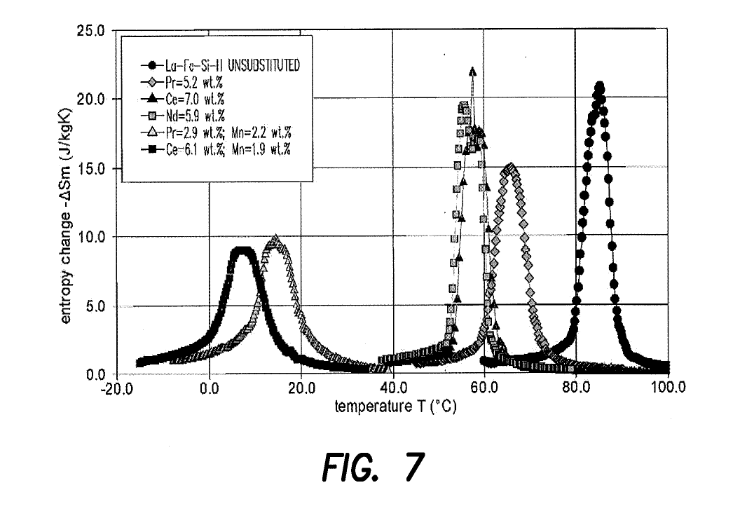

FIG. 7 illustrates a graph of the entropy change (−ΔSₘ) for a magnetic field change of 16 kOe as a function of temperature for substantially fully hydrogenated samples containing different metallic substitutions.

The samples were made by mixing appropriate starting powders, which were produced similarly to the previous embodiments, in appropriate amounts and isostatically pressing them to form green bodies which were then sintered at various temperatures in the range of 1090° C. to 1160° C. The sinter temperature for each composition is given in Table 1. After sintering, the samples were homogenised at 1050° C. for 6 hours and rapidly cooled to room temperature.

To hydrogenate the samples, the samples were heated in argon to a temperature of 500° C. and the argon exchanged for 1.9 bars of hydrogen and slowly cooled to room temperature. The compositions of the samples are summarised in Table 1.

The La(Fe,Si)₁₃-phase has a Curie temperature of +85° C. By substituting Ce, Nd or Pr alone, a reduction in the Curie temperature was achieved compared to a ternary La(Fe,Si)₁₃ composition. Cerium in the form of cerium misch metal (Ce(MM)) having a composition of 26.2 wt % La, 16 wt % Nd, 5.2 wt % Pr, rest Ce, was used. The combination of Pr and Mn and Ce and Mn results in a larger reduction in the Curie temperature than the use of Pr, Nd or Ce alone. The entropy change for the samples including Pr, Nd and Ce alone is not significantly lower than that achieved through Mn alone, see FIG. 2.

The combination of Ce and Mn can be used to adjust the peak temperature over the entire temperature range which is technically relevant for domestic cooling.

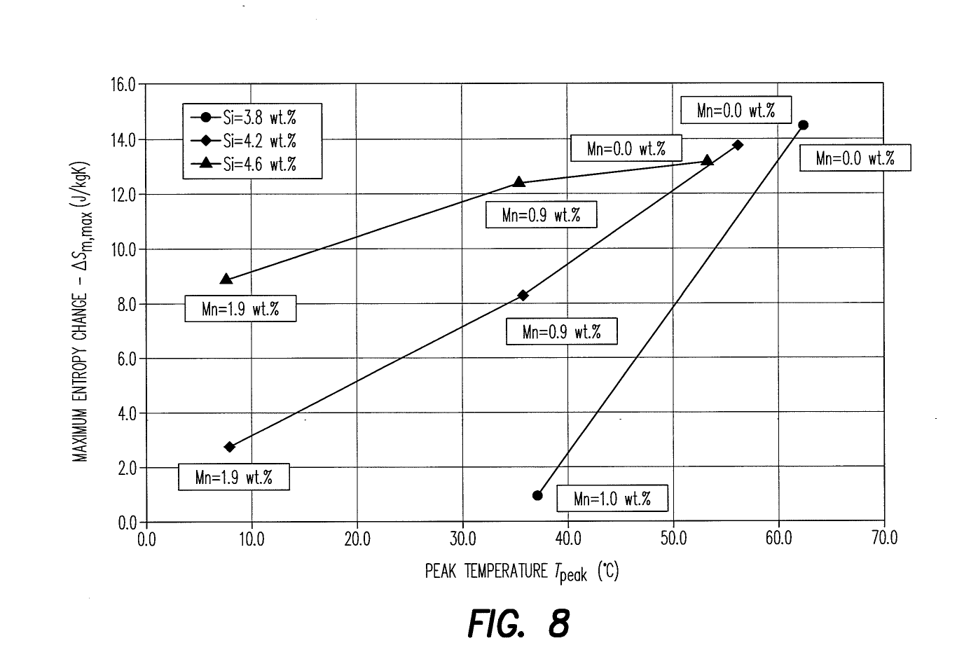

FIG. 8 illustrates a graph of the maximum entropy change (−ΔS_{m, max}) for samples having differing Mn and Si contents. FIG. 8 illustrates that a reduction in the entropy change for a (La,Ce)(Fe,Mn,Si)₁₃ composition with 3.8 wt % Ce(MM) can be at least partly compensated by an appropriate increase in the silicon content. The following relationship was found to be useful to calculate an appropriate silicon content:

Siₘ=3.85−0.045×Mnₘ²+0.2965×Mnₘ

wherein Siₘ is the metallic weight fraction of silicon and Mnₘ is the metallic weight fraction of manganese.

If cobalt is included in combination with manganese, then the following relationship was found to be useful:

Siₘ=3.85−0.0573×Coₘ−0.045×Mnₘ²+0.2965×Mnₘ

wherein Si, is the metallic weight fraction of silicon, Mnₘ is the metallic weight fraction of manganese and Coₘ is metallic weight fraction of cobalt.

If Ce(MM) is included, the silicon content is selected according to the relationship:

Siₘ=3.85−0.045×Mnₘ²+0.2965×Mnₘ+(0.198−0.006×Mnₘ)×Ce(MM)ₘ

wherein Ce(MM)ₘ is the metallic weight fraction of cerium misch metal.

In the following embodiment, the five working components are desired with a Curie temperature of 8.5° C., 11.6° C., 14.9° C., 18.2° C. and 21.3° C., respectively. The above equations were used to determine the composition of the La, Si and Mn contents required to produce a Curie temperature of 3.5° C. and 26.3° C., respectively, in a phase with the respective metallic components that is fully hydrogenated. The compositions are summarized in Table 2 and are 16.7 wt % La, 4.33 wt % Si, 2.86 wt % Mn, rest Fe and 16.7 wt % La, 4.26 wt % Si and 2.02 wt % Mn, rest Fe.

TABLE 2

| | Laₘ | Siₘ | Mnₘ | T_{C,hyd} |
|---|---|---|---|---|
| | (wt. %) | (wt. %) | (wt. %) | (° C.) |
| MFP-1129 | 16.7 | 4.33 | 2.86 | 3.5 |
| MFP-1130 | 16.7 | 4.26 | 2.02 | 26.3 |

Precursor powders produced similarly to the previous embodiments were mixed to give a total batch weight of around 2500 g which was mixed in steel cans with 1250 g of steel balls having diameters of 6 mm, 10 mm and 15 mm for 4 hours on a rolling mill.

These two powders were mixed in appropriate amounts as illustrated in Table 3 in order to achieve the desired five Curie temperatures 8.45° C., 11.55° C., 14.85° C., 18.15° C. and 21.25° C. These powder mixtures were mixed with 1.5% isopropanol, isostatically pressed and sintered by heating to a temperature of 1095° C. for 3 hours in a vacuum followed by 1 hour in argon and cooling in 1 hour to a temperature of 1050° C. This temperature was held for 6 hours before rapidly cooling the samples to room temperature.

TABLE 3

| | MFP-1129 | MFP-1130 | T_{C,soll} |
|---|---|---|---|
| composition | (g) | (g) | (° C.) |
| 1 | 513.77 | 236.23 | 8.45 |
| 2 | 411.34 | 338.66 | 11.55 |
| 3 | 302.31 | 447.69 | 14.85 |
| 4 | 193.28 | 556.72 | 18.15 |
| 5 | 90.859 | 659.14 | 21.25 |

The five samples were packed individually in iron foil and hydrogenated as follows. The samples were heated under a vacuum to 500° C., 1.9 bars of hydrogen was fed into the furnace and the samples were cooled to a temperature of less than 100° C. Samples 3 and 4 were cooled more quickly to room temperature. However, sample 4 was left overnight in an atmosphere of 1.9 bars of hydrogen.

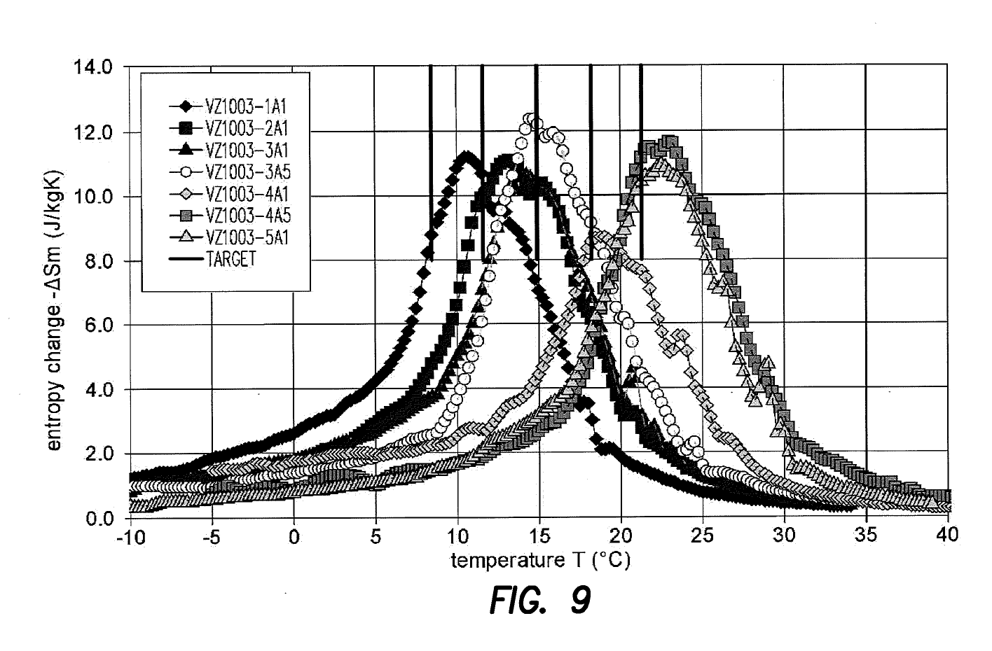

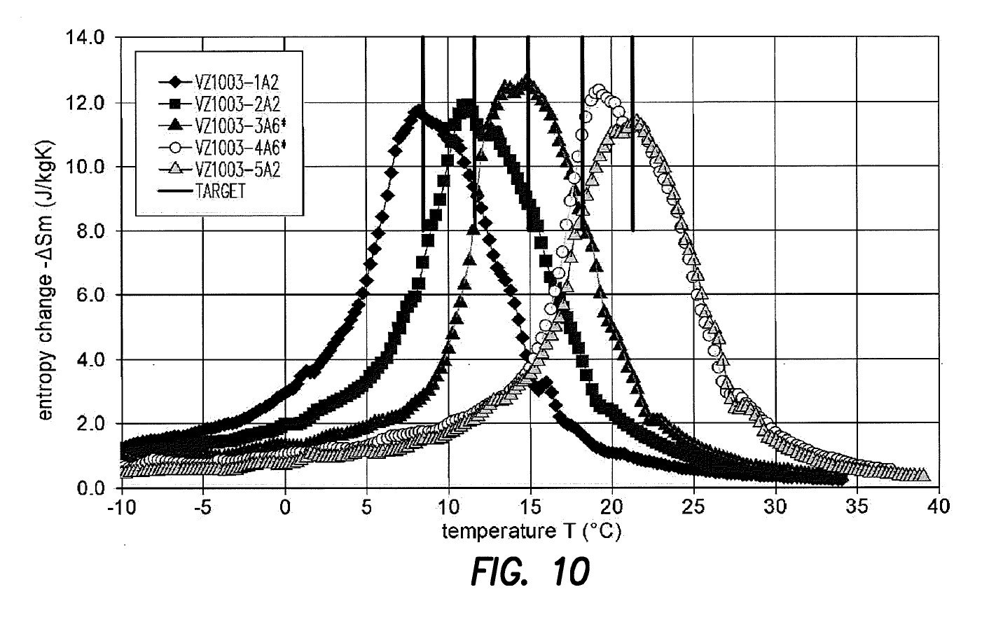

The magnetocaloric properties of the samples were measured and are summarised in Table 4 and FIG. 9. In the tables and fig-ures the samples, 1, 2, 3, 4, and 5 are denoted VZ1003-MCE-1XX, VZ1003-MCE-2XX and so on. The two samples 3 and 4 were cooled more quickly and had a Curie temperature, corresponding to the temperature at which the greatest entropy change (−ΔSₘ) occurs in FIG. 9, which was slightly lower than the desired Curie temperature denoted in FIG. 9 as target. Samples 1, 2 and 5 each have a Curie temperature similar to the desired value. Samples 3 and 4 were re-hydrogenated by heating to 150° C. whereupon the atmosphere was changed for 1.9 bars of hydrogen and then cooled slowly overnight. Table 4 and FIG. 10 illustrate that after this heat treatment the Curie temperature of samples 3 and 4, as indicated by * in table 4, and by the position of the peak temperature to the target temperature illustrated in FIG. 10, is close to the desired T_{c}.

TABLE 4

| sample | | −ΔS_{m.max.} | −ΔS_{m.max.} | T_{PEAK} | T_{PEAK} | ΔT_{FWHM} | |
|---|---|---|---|---|---|---|---|
| no. | composition | J/(kg · K) | kJ/(m³ · K) | (° C.) | (K) | (° C.) | stabilised |
| VZ1003-MCE-1A1 | 1 | 11.10 | 75.70 | 11.47 | 285 | 9.40 | no |
| VZ1003-MCE-1A2 | 1 | 11.58 | 78.98 | 9.22 | 282 | 9.39 | yes |
| VZ1003-MCE-2A1 | 2 | 11.00 | 77.03 | 13.97 | 287 | 9.43 | no |
| VZ1003-MCE-2A2 | 2 | 11.67 | 81.73 | 12.29 | 285 | 8.99 | yes |
| VZ1003-MCE-3A1 | 3 | 10.61 | 74.57 | 14.68 | 288 | 8.80 | no |
| VZ1003-MCE-3A2 | 3 | 8.65 | 60.79 | 11.61 | 285 | 12.78 | yes |
| VZ1003-MCE-3A3 | 3 | 10.36 | 72.81 | 14.52 | 288 | 9.09 | no |
| VZ1003-MCE-3A4 | 3 | 7.82 | 54.96 | 9.83 | 283 | 15.30 | yes |
| VZ1003-MCE-3A5* | 3 | 12.15 | 85.39 | 15.84 | 289 | 8.74 | no |
| VZ1003-MCE-3A6* | 3 | 12.52 | 87.99 | 15.08 | 288 | 8.35 | yes |
| VZ1003-MCE-4A1 | 4 | 8.65 | 60.49 | 19.65 | 293 | 9.56 | no |
| VZ1003-MCE-4A2 | 4 | 9.12 | 63.78 | 18.00 | 291 | 9.40 | yes |
| VZ1003-MCE-4A3 | 4 | 8.90 | 62.24 | 20.58 | 294 | 10.26 | no |
| VZ1003-MCE-4A4 | 4 | 8.83 | 61.75 | 16.88 | 290 | 11.18 | yes |
| VZ1003-MCE-4A5* | 4 | 11.46 | 80.14 | 23.06 | 296 | 9.20 | no |
| VZ1003-MCE-4A6* | 4 | 12.18 | 85.17 | 20.86 | 294 | 8.71 | yes |
| VZ1003-MCE-5A1 | 5 | 10.87 | 76.02 | 22.50 | 296 | 9.12 | no |
| VZ1003-MCE-5A2 | 5 | 11.29 | 78.96 | 21.31 | 294 | 8.90 | yes |

The working components were milled and sieved to produce powders having an average particle size in the range of 250 μm to 400 μm. As can be illustrated by the results given in Table 5 for samples 1 and 3 in comparison with the results given in Table 4, this additional milling did not appear to significantly affect the magnetocaloric properties.

TABLE 5

| sample | | −ΔS_{m.max.} | −ΔS_{m.max.} | T_{PEAK} | T_{PEAK} | ΔT_{FWHM} | |
|---|---|---|---|---|---|---|---|
| no. | composition | J/(kg · K) | kJ/(m³ · K) | (° C.) | (K) | (° C.) | stabilised |
| VZ1003-MCE-1B1 | 1 | 10.79 | 73.59 | 11.93 | 285 | 9.46 | no |
| VZ1003-MCE-1B2 | 1 | 11.13 | 75.91 | 8.84 | 282 | 9.07 | yes |
| VZ1003-MCE-3B3 | 3 | 12.04 | 84.32 | 17.27 | 290 | 9.13 | yes |

A further heat treatment was carried out by heating the final samples to around 140° C. in argon for around 30 minutes and then cooled in flowing argon to room temperature. The effect of this stabilizing heat treatment is illustrated by the two sets of data in Table 4 indexed by the column “stabilized”.

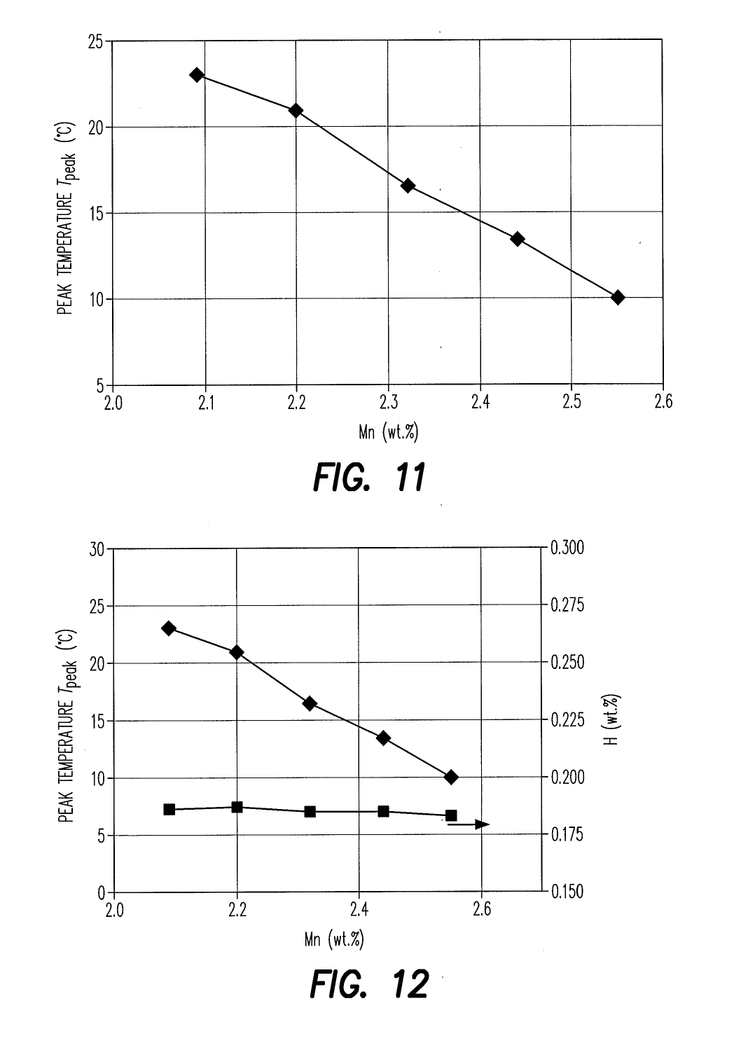

As is summarised in Table 6 and illustrated in FIGS. 11 and 12, the peak temperature Tₚₑₐₖ (° C.) which corresponds to the temperature at which the greatest entropy change occurred and which corresponds to the Curie temperature, decreases for increasing manganese content. As is illustrated in FIG. 12, hydrogen content of the five samples of differing manganese content is generally similar. The differing Curie temperatures are achieved by increasing the manganese content.

TABLE 6

| | composition | | | | |
|---|---|---|---|---|---|
| | 1 | 2 | 3 | 4 | 5 |
| T_{Peak} (° C.) | 10.0 | 13.4 | 16.5 | 20.9 | 23.0 |
| Mn (wt. %) | 2.55 | 2.44 | 2.32 | 2.2 | 2.09 |
| H (wt. %) | 0.183 | 0.185 | 0.185 | 0.187 | 0.186 |
| C (wt. %) | 0.041 | 0.039 | 0.040 | 0.042 | 0.042 |

A possible explanation for the improved ageing behaviour of the fully hydrogenated samples is as follows. It may be assumed that even at room temperature the hydrogen atoms, which are interstitially arranged in the NaZn₁₃-type structure of the La₁₋ₐRₐ(Fe_{1-x-y}T_{y}Mₓ)₁₃H_{z} phase, have a relatively high mobility. Evidence for this is the observation of the loss of hydrogen from the structure at temperatures above around 150° C.

Furthermore, the magnetic phase transition in these alloys from the ferromagnetic state to the paramagnetic state is connected with an increase in volume of around 1.5%. If a partially hydrogenated alloy, in which not all of the available interstitial sites are filled with hydrogen atoms, is stored at a temperature near that of the Curie temperature, it is possible that the hydrogen atoms move against the concentration gradient and diffuse from regions with a lower hydrogen content in the direction of regions with a higher hydrogen content.

The hydrogen atoms may diffuse from the paramagnetic region with the lower hydrogen content but a small volume into the ferromagnetic region with a higher hydrogen content but also a larger lattice constant and greater volume. This movement is likely to occur at a temperature in the range of the Curie temperature as in this region the volume difference between the two phases can be considered to be the driving force.

This provides an explanation as to the stability of the fully hydrated La₁₋ₐRₐ(Fe_{1-x-y}T_{y}Mₓ)₁₃H_{z} phase if stored at the Curie temperature in that the interstitial sites are fully occupied. Therefore, the hydrogen atoms cannot diffuse through the sample between occupied and unoccupied interstitial sites and create low concentration and high concentration regions.

However, since the fully hydrated La₁₋ₐRₐ(Fe_{1-x-y}T_{y}Mₓ)₁₃H_{z} phase has a Curie temperature of greater than around +80° C., desired temperatures of less than +80° C. suitable for refrigeration applications can be produced by substituting appropriate metal ions for La and Fe.

La may be substituted by rare earth elements such as Y, Nd and Pr which have a small atomic radius. This should result in a reduction of the lattice parameter and a reduction in the Curie temperature. Alternatively, or in addition, Fe can be substituted with 3d elements which have a lower coordination number and therefore a lower number of electrons in the 3d band which affect magnetism. Substitutions of Mn, Cr, V and Ti for Fe can lead to reduction in the Curie temperature. Should temperatures above +80° C. be desired, these can be achieved by substituting Fe with Co and/or Ni.

If a curie temperature close to 80° C. is desired, elements such as Mn and Co can both be substituted in the La(Fe,Siₙ)H_{z} phase. In this case the effect of each the substituting metallic elements on the Curie temperature cancels the other out. However, alloys of this composition display a smaller hysteresis compared to La(Fe,Si)₁₃H_{z} alloys with the same Curie temperature, but without the two different substituting elements.

However, for all metallic element compositions, the hydrogen content is kept has high as possible to provide a stable Curie temperature.

The invention having been described herein with respect to certain of its specific embodiments and examples, it will be understood that these do not limit the scope of the appended claims.

1. A working component for magnetic heat exchange comprising a magnetocalorically active phase comprising La₁₋ₐRₐ(Fe_{1-x-y}T_{y}Mₓ)₁₃H_{z}, a hydrogen content, z, 90% or higher of a hydrogen saturation value, zₛₐₜ, and values of a, x and y selected to give a Curie temperature T_{c}, M being one or more of the elements from the group consisting of Al and Si, T being one or more of the elements from the group consisting of Co, Ni, Mn, Cr, Cu, Ti and V and R being one or more of the elements from the group consisting of Ce, Nd, Y and Pr, T_{cmax} being the Curie temperature of a La₁₋ₐRₐ(Fe_{1-x-y}T_{y}Mₓ)₁₃H_{z} phase comprising a hydrogen content z=zₛₐₜ and said selected values of a, x and y, wherein (T_{cmax}−T_{c})≦20K.

2. The working component according to claim 1, wherein the hydrogen content, z, is 95% or higher of the hydrogen saturation value, zₛₐₜ and (T_{cmax}−T_{c})≦10K.

3. The working component according to claim 1, wherein 1.2≦z≦3.

4. The working component according to claim 1, wherein 1.4≦z≦3.

5. The working component according to claim 1, wherein 0.05≦x≦0.3, 0.003≦y≦0.2 and optionally 0.005≦a≦0.5.

6. The working component according to claim 1, wherein 0.005≦a≦0.5 and 0.05≦x≦0.2 and 0.003≦y≦0.2.

7. The working component according to claim 1, wherein T is Mn and the Curie temperature T_{c} of the working component lies within ±10K of the value of the Curie temperature, T_{c(calc)}, derived from the relationship T_{c(calc)}(° C.)=80.672−26.957×Mnₘ, wherein Mnₘ is the metallic weight fraction of manganese.

8. The working component according to claim 7, wherein T_{c} lies within ±5K of T_{c(calc)}.

9. The working component according to claim 1, wherein M is Si and the metallic weight fraction of Si, Si_{act}, lies within ±5% of the value of the metallic weight fraction of silicon, Siₘ, derived from the relationship Siₘ=3.85−0.0573×Coₘ−0.045×Mnₘ²+0.2965×Mnₘ, wherein Coₘ is the metallic weight fraction of cobalt and Mnₘ is the metallic weight fraction of manganese.

10. The working component according to claim 1, wherein M is Si and the metallic weight fraction of Si, Si_{act}, lies within ±5% of the value of the metallic weight fraction of silicon, Siₘ, derived from the relationship Siₘ=3.85−0.045×Mnₘ²+0.2965×Mnₘ+(0.198−0.066×Mnₘ)×Ce(MM)ₘ, wherein Mnₘ is the metallic weight fraction of manganese and Ce(MM)ₘ is the metallic weight fraction of cerium misch metal.

11. The working component according to claim 9, wherein Si_{act} lies within ±−2% of Siₘ.

12. The working component according to claim 1, wherein the working component comprises powder.

13. The working component according to claim 1, wherein the working component comprises a sintered block.

14. The working component according to claim 1, wherein the working component comprises a reactively sintered block.

15. The working component according to claim 1, wherein the working component comprises a compacted powder.

16. The working component according to claim 1, wherein the working component further comprises a magnetocalorically passive phase.

17. The working component according to claim 16, wherein the magnetocalorically passive phase provides a matrix in which the magnetocalorically active phase is embedded.

18. An article for magnetic heat exchange comprising two or more working components according to claim 1, wherein the two or more working components comprising differing values of a and/or x and/or y and differing Curie temperatures.

19. The article according to claim 18, wherein the article comprises at least three working components arranged so that the Curie temperature of the at least three working components increases in a direction of the article.

20. A method of producing a working component for magnetic refrigeration, comprising:
selecting a desired Curie temperature,
selecting an amount of one or more elements T, R and M, wherein T is one or more of the elements from the group consisting of Mn, Co, Ni, Cu, Ti, V and Cr, R is one or more of the elements from the group consisting of Ce, Nd, Y and Pr, M is one of the elements Si and Al, the amount of the one or more elements T, R and M being selected to produce the desired Curie temperature when included in a La₁₋ₐRₐ(Fe_{1-x-y}T_{y}Mₓ)₁₃H_{z} phase having a hydrogen content that is at least 90% of a hydrogen saturation value, zₛₐₜ,
mixing the amount of the selected elements T, R and M with La and Fe or precursors thereof in amounts suitable for producing the La₁₋ₐRₐ(Fe_{1-x-y}T_{y}Mₓ)₁₃H_{z} phase with the desired Curie temperature to produce a precursor powder mixture,
heat treating the precursor powder mixture to produce an intermediate product comprising a La₁₋ₐRₐ(Fe_{1-x-y}T_{y}Mₓ)₁₃H_{z} phase with z=0,
hydrogenating the intermediate product to produce a working component comprising the La₁₋ₐRₐ(Fe_{1-x-y}T_{y}Mₓ)₁₃H_{z} phase comprising the desired Curie temperature and a hydrogen content z of at least 90% of the hydrogen saturation value, zₛₐₜ.

21. The method according to claim 20, wherein, the amount of one or more of the elements R, T and M is selected within the ranges 0.05≦x≦0.2, 0.003≦y≦0.2 and optionally 0.005≦a≦0.5.

22. The method according to claim 20 or claim 21, wherein, the amount of one or more of the elements R, T and M is selected within the ranges 0.005≦a≦0.5 and 0.05≦x≦0.2 and 0.003≦y≦0.2.

23. The method according to claim 20, wherein the element T comprises Mn and the amount of manganese Mnₘ to produce the desired Curie temperature T_{c} is selected according to T_{c} (° c.)=80.672−26.957×Mnₘ, wherein Mnₘ is the metallic weight fraction of manganese.

24. The method according to claim 20, wherein M is Si and the amount of Si is selected according to Siₘ=3.85−0.0573×Coₘ−0.045×Mnₘ²+0.2965×Mnₘ, wherein Siₘ is the metallic weight fraction of silicon, Mnₘ is the metallic weight fraction of manganese and Coₘ is the metallic weight fraction of cobalt.

25. The method according to claim 20, wherein M is Si and the amount of Si is selected according to Siₘ=3.85−0.045×Mnₘ²+0.2965×Mnₘ+(0.198−0.066×Mnₘ)×Ce(MM)ₘ, wherein Siₘ is the metallic weight fraction of silicon, Mnₘ is the metallic weight fraction of manganese and Ce(MM)ₘ is the metallic weight fraction of cerium misch metal.

26. The method according to claim 20, further comprising pressing the precursor powder mixture to form one or more-green bodies.

27. The method according to claim 20, wherein the hydrogenating of the intermediate product produces the La₁₋ₐRₐ(Fe_{1-x-y}T_{y}Siₓ)₁₃H_{z} phase with a hydrogen content z of 1.2≦z≦3.

28. The method according to claim 20, wherein the hydrogenating comprises heat treating under a H₂ partial pressure of 0.5 to 2 bar.

29. The method according to claim 20, wherein the H₂ partial pressure is increased during the hydrogenating.

30. The method according to claim 20, wherein the hydrogenating comprises heat treating at a temperature in the range 0° C. to 100° C.

31. The method according to claim 30, wherein the hydrogenating comprises heat treating at a temperature in the range 15° C. to 35° C.

32. The method according to claim 20, wherein the hydrogenating comprises a dwell at a temperature T_{hyd}, wherein 300° C.≦T_{hyd}≦700° C.

33. The method according to claim 32, wherein the hydrogenating comprises a dwell at a temperature T_{hyd}, wherein 300° C.≦T_{hyd}≦700° C. followed by cooling to a temperature of less than 100° C.

34. The method according to claim 30, wherein the hydrogenating comprises:
heating the intermediate product from a temperature of less than 50° C. to at least 300° C. in an inert atmosphere,
introducing hydrogen gas only when a temperature of at least 300° C. is reached,
maintaining the intermediate product in a hydrogen containing atmosphere at a temperature in the range 300° C. to 700° C. for a selected duration of time, and
cooling the intermediate product to a temperature of less than 50° C. to provide the working component.

35. The method of claim 34, wherein the cooling of the intermediate product comprises cooling to a temperature of less than 50° C. in a hydrogen-containing atmosphere.

36. The method according to claim 20, wherein the introducing of the hydrogen gas is only when a temperature of 400° C. to 600° C. is reached.

37. The method according to claim 20, wherein after hydrogenating, the working component comprises at least 0.18 wt % hydrogen.

38. The method according to claim 20, wherein the heat treating of the precursor powder mixture is at a temperature Tₛᵢₙₜₑᵣ, wherein 1050° C.≦Tₛᵢₙₜₑᵣ≦1200° C.

39. The method according to claim 20, wherein the heat treating of the precursor powder mixture comprises a multi-step heat treating process.

40. The method according to claim 39, wherein the multi-step heat treatment comprises a first dwell at Tₛᵢₙₜₑᵣ for a time t₁ in vacuum and a time t₂ in argon, followed by cooling to a temperature T₁, wherein T₁<Tₛᵢₙₜₑᵣ, followed by a second dwell at T₁ for a time t₃ followed by rapid cooling.

41. The method according to claim 40, wherein 1000° C.≦T₁≦1080° C. and/or 0.5 h≦t≦₁10 h and/or 0.5 h≦t₂≦10 h and/or 1 h≦t₃≦20 h and/or the rapid cooling takes place at a rate of 5 to 200° C./min.

42. The method according to claim 24, wherein the working component comprises a silicon content Si, Si_{act}, that lies within ±5% of Siₘ.

43. The method according to claim 42, wherein Si_{act} lies within ±2% of Siₘ.

44. The method according to claim 20, wherein the mixing is carried out using steel balls and optionally isopropanol.

45. The method according to claim 20, further comprising milling the working component to produce working component powder.

46. The method according to claim 45, further comprising heat treating the working component powder at a temperature in the range 100° C. to 200° C. for 5 to 60 minutes.

47. The method according to claim 46, wherein the heat treating is carried out in Argon.

48. The method according to claim 20, further comprising removing at least one portion of the working component whilst the working component remains at a temperature above the Curie temperature T_{c} or below the Curie temperature T_{c}.

49. The method according to claim 48, wherein the working component is heated at a temperature sufficient to prevent a magnetocalorically active phase from undergoing a phase change whilst removing, the portion of the working component.

50. The according to claim 48, wherein after the formation of a magnetocalorically active phase, the working component is maintained at a temperature above its magnetic phase transition temperature T_{c} until working of the working component has been completed.

51. The method according to claim 48, wherein the working component is cooled at a temperature sufficient to prevent a magnetocalorically active phase from undergoing a phase change whilst removing the portion of the component.

52. The method according to claim 48, wherein a magnetocalorically active phase exhibits a temperature dependent transition in length or volume and the at least one portion is removed at a temperature above the transition or below the transition in length or volume.

53. The method according to claim 52, wherein the transition is characterized by (L_{10%}−L_{90%})×100/L(T)>0.35.

54. The method according to claim 20, further comprising:
heat treating the working component at a temperature T₂ to form an intermediate article comprising at least one permanently magnetic phase, wherein T₂<Tₛᵢₙₜₑᵣ.

55. The method according to claim 54, wherein the heat treating of working component is under conditions selected so as to decompose a La₁₋ₐRₐ(Fe_{1-x-y}T_{y}Mₓ)₁₃H_{z} phase having a NaZn₁₃-type crystal structure and form at least one α-Fe-type phase in the intermediate article.

56. The method according to claim 54, wherein the heat treating of working component is under conditions selected so as to produce an α-Fe content of greater than 50 vol % in the intermediate article.

57. The method according to claim 54, further comprising:
working the intermediate article by removing at least one portion of the intermediate article, and then
heat treating the intermediate article to produce a second working component product comprising at least one magnetocalorically active La₁₋ₐRₐ (Fe_{1-x-y}T_{y}Mₓ)₁₃H_{z} phase.

58. The method according to claim 57, wherein the heat treating of the intermediate article produces an α-Fe content of less than 5 vol % in the second working component product.

59. The method according to claim 57, wherein the heat treating of the intermediate article is at a temperature T₃ to produce the second working component product, wherein T₃>T₂.

60. The method according to claim 59, wherein T₃<Tₛᵢₙₜₑᵣ.

61. The method according to claim 54, wherein the composition of the working component is selected so as to produce a reversible decomposition of the phase with the NaZn₁₃-type crystal structure at T₂ and to produce a reformation of the NaZn₁₃-type crystal structure at T₃.

62. The method according to claim 48, wherein the at least one portion is removed by one or more of machining, mechanical grinding, mechanical polishing, chemical-mechanical polishing, electric spark cutting, wire erosion cutting, laser cutting and laser drilling or water beam cutting.

63. The method according to claim 48, wherein the at least one portion is removed so as to produce at least two separate pieces.

64. The method according to claim 48, wherein the at least one portion is removed so as to produce at least one channel formed in a surface or at least one through-hole.
